(19) United States
(12) Patent Application Publication
(10) Pub. No.: US 2012/0162004 A1
(43) Pub. Date: Jun. 28, 2012

(54) APPARATUS AND METHOD FOR ESTIMATING DIRECTION OF ARRIVAL OF SIGNAL IN COMMUNICATION SYSTEM

(75) Inventors: Sang-Tae KIM, Daejeon (KR); Gwangmoon Park, Daejeon (KR); Seong-Yun Lee, Daejeon (KR); Haeng-Sook Ro, Daejeon (KR); Mi-kyung Suk, Daejeon (KR); Yong-Seok Choi, Daejeon (KR)

(73) Assignee: ELECTRONICS AND TELECOMMUNICATIONS RESEARCH INSTITUTE of Daejeon

(21) Appl. No.: 13/334,969

(22) Filed: Dec. 22, 2011

(30) Foreign Application Priority Data
Dec. 23, 2010 (KR) 10-2010-0133566

(51) Int. Cl. G01S 13/02

(52) U.S. Cl. 342/147

(57) ABSTRACT

Disclosed is an apparatus and method for estimating a direction of arrival (DOA) of a signal, which improves DOA estimation performance of a reception signal having a low signal to interference and noise ratio (SINR) in a communication system. In the method, a received signal is converted into a signal of a frequency region. A noise signal is separated from the signal converted into the signal of the frequency region. A noise region is filtered by setting an occupied bandwidth from the signal having the noise signal separated therefrom. A DOA of the signal obtained through the filtering of the noise region is estimated.

### CROSS-REFERENCE TO RELATED APPLICATIONS

The present application claims priority of Korean Patent Application No. 10-2010-0133566, filed on Dec. 23, 2010, which is incorporated herein by reference in its entirety.

### BACKGROUND OF THE INVENTION

1. Field of the Invention

Exemplary embodiments of the present invention relate to a communication system; and, more particularly, to an apparatus and method for estimating a direction of arrival (DOA) of a signal, which improves DOA estimation performance of a reception signal having a low signal to interference and noise ratio (SINR) in a communication system for communicating signals.

2. Description of Related Art

In a communication system, the estimation of a direction of arrival (DOA) of a signal is used to detect a direction of a signal source by minimizing an error of the signal received by a signal receiver. The estimation is performed under the assumption of an ideal environment for estimating a DOA of a signal, including an environment of signals, antenna reception conditions, and the like. However, signal noises and signal interferences exist due to radar pulses, multiple reflection waves, etc. in an environment in which radio waves are transmitted/received by radio.

Accordingly, a signal received to estimate a DOA of signal contains a noise signal caused by noise. If the DOA of the signal is estimated by receiving the signal containing the noise signal, there occurs an error caused by estimating the DOA of the signal.

### SUMMARY OF THE INVENTION

An embodiment of the present invention is directed to an apparatus and method for estimating a DOA of a signal, which reduces an error caused by a noise signal in a communication system.

Another embodiment of the present invention is directed to an apparatus and method for estimating a DOA of a signal, which improves DOA estimation performance of a reception signal having a low signal to interference and noise ratio (SINR) in a communication system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for estimating a direction of arrival (DOA) of a signal in a communication system includes a signal reception unit configured to receive a signal; a pre-processing unit configured to convert the received signal into a signal of a frequency region and denoise the signal converted into the signal of the frequency region, a signal rearrangement processing unit configured to measure an occupied bandwidth through spectrum analysis of the denoised signal and filter a noise region based on the occupied bandwidth, and a DOA estimation unit configured to estimate a DOA of the signal obtained by filtering the noise region using a DOA estimating algorithm.

In accordance with another embodiment of the present invention, a method for estimating a DOA of a signal in a communication system includes receiving a signal, converting the received signal into a signal of a frequency region, separating a noise signal from the signal converted into the signal of the frequency region, filtering a noise region by setting an occupied bandwidth from the signal having the noise signal separated therefrom, and estimating a DOA of the signal obtained through the filtering of the noise region.

In accordance with another embodiment of the present invention, a method for estimating a DOA of a signal in a communication system includes receiving a signal, converting the received signal into a digital signal through sampling, converting the digital signal into a signal of a frequency region, separating a noise signal from the signal of the frequency region, obtaining maximum and minimum frequencies of an occupied bandwidth through spectrum analysis from the signal having the noise signal separated therefrom, filtering a noise region containing the noise signal using the maximum and minimum frequencies, and estimating a DOA of the signal obtained by filtering the noise region.

### BRIEF DESCRIPTION OF THE DRAWINGS

FIG. 1 is a block diagram illustrating an apparatus for estimating a direction of arrival (DOA) of a signal in a communication system in accordance with an embodiment of the present invention.

FIG. 2 illustrates a signal reception unit illustrated in FIG. 1.

FIG. 3 illustrates an operation of estimating an occupied bandwidth for removing a noise signal in the communication system in accordance with the embodiment of the present invention.

FIG. 4 is a graph illustrating spectra of a signal sample before/after signal pre-processing in the communication system in accordance with the embodiment of the present invention.

FIGS. 5 and 6 are graphs illustrating eigen values in a covariance matrix in the communication system in accordance with the embodiment of the present invention.

FIG. 7 is a graph illustrating a result obtained by estimating a DOA of a signal in the communication system in accordance with the embodiment of the present invention.

FIG. 8 is a flowchart illustrating a method for estimating a DOA of a signal in the communication system in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

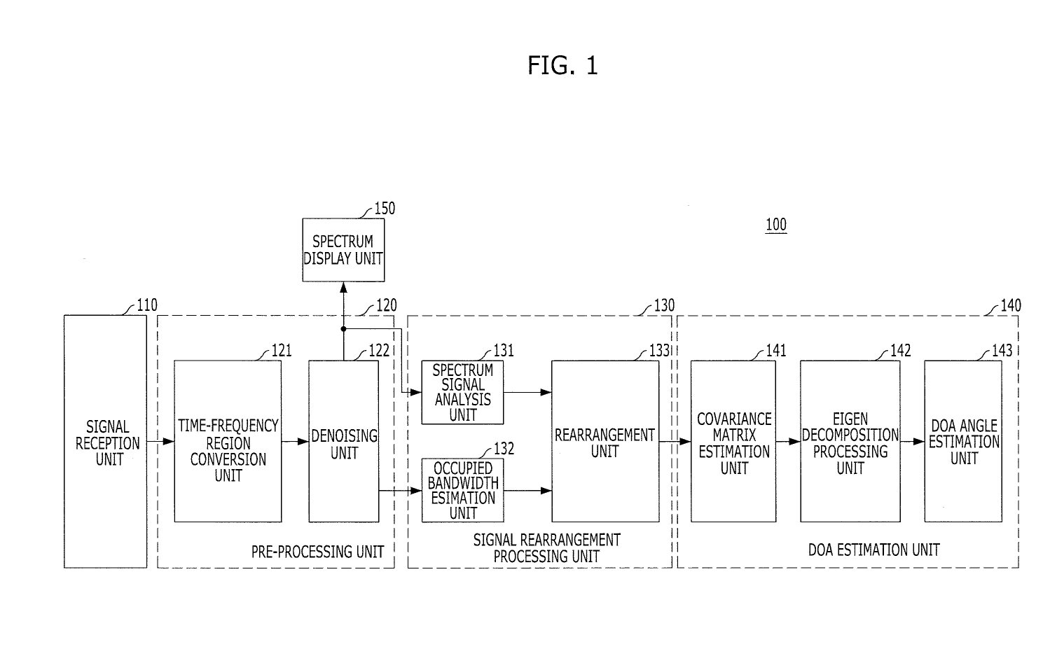

Exemplary embodiments of the present invention relate to an apparatus and method for estimating a direction of arrival (DOA) of a signal, which improves DOA estimation performance of a reception signal having a low signal to interference and noise ratio (SINR) in a communication system. Here, the apparatus and method will be mainly described in the exemplary embodiments of the present invention. However, the apparatus and method in accordance with the exemplary embodiments of the present invention may also be applied to a radio wave measuring system. That is, the present invention proposes the apparatus and method not only in the communication system but also in the radio wave measuring system, and the apparatus and method of the present invention improves DOA estimation performance of a reception signal having a low SINR in the communication system and the radio wave measuring system. Hereinafter, an apparatus for estimating a DOA of a signal in accordance with an embodiment of the present invention will be described in detail with reference to FIG. 1.

FIG. 1 is a block diagram illustrating an apparatus for estimating a DOA of a signal in a communication system in accordance with an embodiment of the present invention.

Referring to FIG. 1, the apparatus 100 includes a signal reception unit 110, a pre-processing unit 120, a signal rearrangement processing unit 130, a DOA estimation unit 140 and a spectrum display unit 150.

The signal reception unit 110 receives a signal through an antenna. The signal reception unit 110 obtains a time sample by sampling the received signal. Here, the time sample may be represented as ‘x(t),’ and is a signal of a time region. The signal reception unit 110 outputs the time sample to the pre-processing unit 120.

The pre-processing unit 120 separates the time sample into an original signal and a noise signal through pre-processing. The pre-processing unit 120 includes a time-frequency region conversion unit 121 and a denoising unit 122.

The time-frequency region conversion unit 121 performs a time-frequency region conversion on the time sample. That is, the time-frequency region conversion unit 121 converts the time region of the time sample into a frequency region, i.e., frequency analysis region. The time-frequency region conversion unit 121 outputs, to the denoising unit 122, the time sample of which time region is converted into the frequency analysis region. Here, the time sample of which the time region is converted into the frequency region, i.e., frequency analysis region may be represented as ‘X(f).’

The denoising unit 122 may separate a noise signal contained in the frequency sample from the original signal by denoising the time sample of which time region is converted into the frequency region. The denoising unit 122 outputs the denoised signal (e.g., denoised X(f)) to the signal rearrangement processing unit 130 and the spectrum display unit 150.

Meanwhile, the time-frequency region conversion unit 121 and the denoising unit 122 may be combined as a single unit.

The signal rearrangement processing unit 130 measures an occupied bandwidth through spectrum analysis of the denoised signal, and filters noise elements based on the occupied bandwidth. The signal rearrangement processing unit 130 includes a signal spectrum analysis unit 131, an occupied bandwidth measurement unit 132 and a rearrangement unit 133.

The signal spectrum analysis unit 131 analyzes a spectrum of the denoised signal. The signal spectrum analysis unit 131 may obtain the amplitude and phase of the signal through the spectrum analysis. The signal spectrum analysis unit 131 outputs the amplitude and phase of the signal to the rearrangement unit 133.

The occupied bandwidth measurement unit 132 may obtain maximum and minimum frequencies of the bandwidth occupied by the denoised signal. The occupied bandwidth measurement unit 132 may measure an occupied bandwidth (OBW) of a signal. The occupied bandwidth measurement unit 132 may obtain a maximum frequency f_{H} and a minimum frequency f_{L} through by measuring the OBW. The OWB is a region containing elements of an actual signal to be received. The occupied bandwidth measurement unit 132 may measure the OBW, for example, using an ex-decibel (x-dB) bandwidth measuring method or a partial power (β %) bandwidth measuring method. The occupied bandwidth measurement unit 132 outputs information on the OBW to the rearrangement unit 133.

The rearrangement unit 133 filters the frequency region in which noise exists using the information on the OWB (e.g., the maximum frequency f_{H} and the minimum frequency I′d. The rearrangement unit 133 rearranges data existing in the OBW. The rearrangement unit 133 outputs the rearranged signal to the DOA estimation unit 140.

The DOA estimation unit 140 estimates a DOA of a signal source by applying a DOA estimating algorithm previously determined from the rearranged signal. A multiple signal classification (MUSIC) algorithm may be used as an example of the DOA estimating algorithm, and it is possible to simultaneously detect directions of a plurality of signals using the MUSIC algorithm. The DOA estimation unit 140 includes a covariance matrix estimation unit 141, an eigen decomposition processing unit 142 and a DOA angle estimation unit 143.

The covariance matrix estimation unit 141 estimates a covariance matrix from the rearranged signal. The filtered covariance matrix may be represented as R[f_{L}, f_{H}]. The covariance matrix estimation unit 141 outputs the covariance matrix to the eigen decomposition processing unit 142.

The eigen decomposition processing unit 142 decomposes an eigen value from the covariance matrix. The eigen decomposition processing unit 142 outputs the eigen value to the DOA angle estimation unit 143.

The DOA angle estimation unit 143 may estimate a DOA angle. The DOA angle estimation unit 143 distinguishes the number of signal spaces and the number of noise spaces and, so that it is possible to estimate the number of signals for estimating the DOA of the signal. The DOA angle estimation unit 143 may estimate a DOA of a signal, e.g., a DOA angle through the estimation of the number of signals. The DOA angle estimation unit 143 may also estimate the DOA of the signal using the amplitude and phase of the signal extracted from the signal spectrum analysis unit 131.

The spectrum display unit 150 displays the spectrum of the denoised signal.

The apparatus 100 for estimating a DOA of a signal in accordance with the embodiment of the present invention converts a reception signal into a signal of a frequency region, i.e., a signal of a frequency analysis region so as to separate a noise signal (e.g., including an interference signal) from the reception signal. As the reception signal is converted into the signal of the frequency analysis region, the apparatus 100 separates the noise signal from the reception signal through a signal denoising process based on time-frequency region conversion, so that the noise signal can be more efficiently separated from the signal of the frequency analysis region as compared with the signal of the time region.

The apparatus 100 uses sample data obtained by filtering the noise signal (or interference signal) through determination of the maximum and minimum frequencies of a bandwidth occupied by the signal of the frequency region, i.e., an OBW.

As described above, the apparatus 100 estimates a DOA of a signal by separating a noise signal from a reception signal, so that it is possible to reduce an error caused by estimating the DOA of the signal.

That is, the apparatus 100 in accordance with the embodiment of the present invention may estimate the DOA of the signal, for example, using a signal with improved SINR.

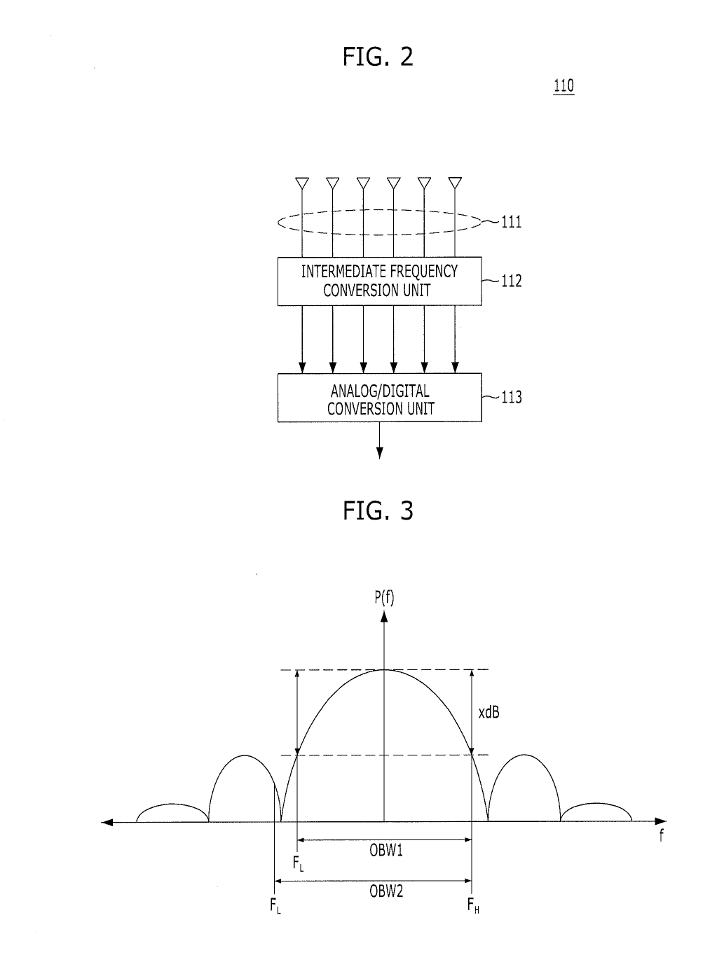

FIG. 2 illustrates the signal reception unit illustrated in FIG. 1.

Referring to FIG. 2, the signal reception unit 110 includes an arrangement antenna 111, an intermediate frequency conversion unit 112 and an analog/digital conversion unit 113.

The arrangement antenna 111 is configured with a plurality of antennas. For example, the plurality of antennas may be arranged in a circular shape. The arrangement antenna 111 may receive a signal through each of the antennas. In this case, the received signal may contain a noise signal according to the wireless environment. Here, the noise signal is a signal except an original signal to be received, and may contain an interference signal.

Meanwhile, it is assumed that the arrangement antenna 111 is configured with M isotropic antennas. Also, it is assumed that N plane waves are incident onto the arrangement antenna 111. In this case, the center angular frequency of the incident plane wave is referred to as ω₀, the envelope of an n-th complex sinusoidal signal is referred to as Sₙ(t), and the relative time delay between a reference point and an m-th antenna is referred to as τₙ(m). The signal xₘ(t) received by the m-th antenna at a time t may be modeled as illustrated in the following Expression 1.

$${x}_{m} ( t ) = {\sum }_{n = 1}^{N} {s}_{n} ( t ) {e}^{j [ {w}_{0} ( t - {τ}_{n} ( m ) ) + {φ}_{n} ]} + {η}_{m} ( t ) \\ {τ}_{n} ( m ) = \frac{{z}_{m} \times {k}_{n}}{c} ( 1 \leq m \leq M ) \qquad Expression 1$$

Here, zₘ(1≦m≦M) denotes a position vector of the m-th antenna, and kₙ(1≦n≦N) denotes a vector of the incident signal. φₙ denotes an arbitrary phase of the n-th signal, and ηₘ(t) denotes a random noise of the m-th antenna. c denotes a propagation velocity of a radio wave.

The steering vector α(θₙ) is independent, which is reception response characteristic of the arrangement antenna 111, corresponding to each DOA angle of the arrangement antenna 111. If it is assumed that the interval between the antennas of the arrangement antenna 111 is a half wavelength or less, α(θₙ) is singularly determined by one DOA. The α(θᵢ) and α(θⱼ) are mutually independent with respect to all DOAs different from one another. That is, when N signals are incident onto the arrangement antenna 111, the order of a steering matrix composed of steering vectors is represented by the following Expression 2.

Expression 2

rankA(θ)=N

When incident signals are incoherent signals, i.e., when the frequencies of the incident signals are different from each other, the order of the matrix is identical to the number of signals as illustrated in the following Expression 3.

Expression 3

rank{Xₛ}=rank{A(θ)}=N

In the estimation of the DOA of the signal, the order of the reception signal may be used as a parameter for estimating the DOA of the signal.

Meanwhile, the arrangement antenna 111 outputs the signals respectively received through the antennas to the intermediate frequency conversion unit 112.

The intermediate frequency conversion unit 112 converts each of the received signals into a signal of an intermediate frequency region. The intermediate frequency conversion unit 112 outputs the received signals converted into the signals of the intermediate frequency region to the analog/digital conversion unit 113.

The analog/digital conversion unit 113 converts the received signals into digital signals. In this case, the analog/digital conversion unit 113 may sample the received signal so as to convert an analog signal into a digital signal. The data matrix composed of L data sampled by the analog/digital conversion unit 113 is represented by the following Expression 4.

$$\begin{matrix}X = [ x ( {t}_{1} ) , x ( {t}_{2} ) , … , x ( {t}_{L} ) ] \\ = {X}_{s} + N \\ = A ( θ ) [ s ( {t}_{1} ) , s ( {t}_{2} ) , … , s ( {t}_{L} ) ] + [ n ( {t}_{1} ) , n ( {t}_{2} ) , … , n ( {t}_{L} ) ]\end{matrix} \qquad Expression 4$$

FIG. 3 illustrates an operation of estimating an occupied bandwidth for removing a noise signal in the communication system in accordance with the embodiment of the present invention.

Referring to FIG. 3, the occupied bandwidth measurement unit 132 measures an occupied bandwidth (OBW) of a signal, in which signal energy is aggregated.

The occupied bandwidth measurement unit 132 may use an ex-decibel (x-dB) bandwidth measuring method or a partial power (β %) bandwidth measuring method.

The first occupied bandwidth OBW1 is a bandwidth measured using the ex-decibel (x-dB) bandwidth measuring method. The occupied bandwidth measurement unit 132 measures an occupied bandwidth when the energy density is distant by x-dB from a previously determined reference level (here, a maximum value) on a probability distribution function (PDF) graph.

A second occupied bandwidth OBW2 is an occupied bandwidth measured using the partial power (β %) bandwidth measuring method. Here, it may be assumed that the partial power is a partial power of 99%. The occupied bandwidth measurement unit 132 measures an occupied bandwidth that occupies a previously determined energy region (99%) based on a central frequency on the PDF graph.

The occupied bandwidth measurement unit 132 determines a maximum frequency (f_{H}) and a minimum frequency (f_{L}), which determine an occupied bandwidth from the reception signal denoised through the pre-processing.

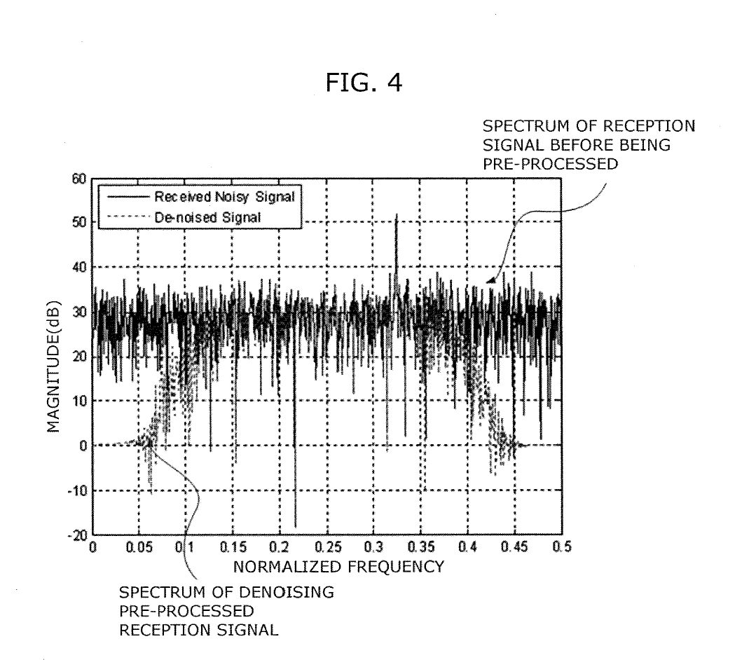

FIG. 4 is a graph illustrating spectra of a signal sample before/after signal pre-processing in the communication system in accordance with the embodiment of the present invention.

Referring to FIG. 4, the abscissa of the graph represents generalized frequencies, and the ordinate of the graph represents amplitudes (dB).

The solid line in the spectrum graph indicates a reception signal before being pre-processed by the pre-processing unit 120. In this case, the reception signal before being pre-processed by the pre-processing unit 120 may be a signal having a signal to noise ration (SNR) of −5 dB.

The dotted line in the spectrum graph indicates a reception signal pre-processed by the pre-processing unit 120. The pre-processing unit 120 may use, for example, a wavelet denoising algorithm. The pre-processing unit 120 may separate a noise signal from the reception signal using the wavelet denoising algorithm.

The spectrum of the signal having the noise signal separated therefrom can be seen through the dotted line in the spectrum graph of FIG. 4.

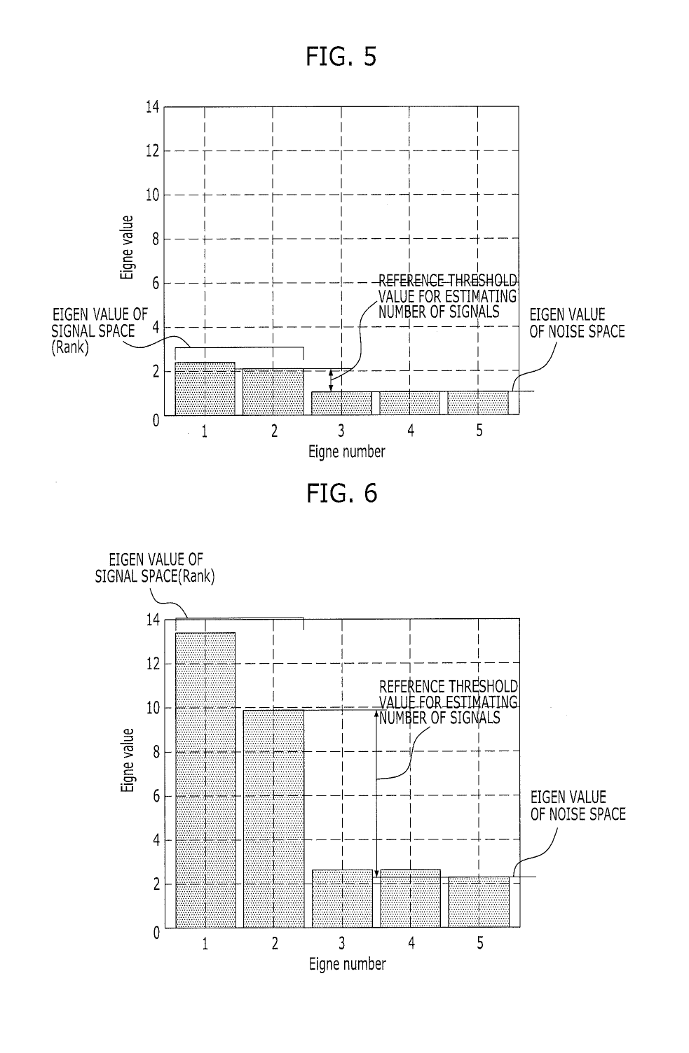

FIGS. 5 and 6 are graphs illustrating eigen values in a covariance matrix in the communication system in accordance with the embodiment of the present invention.

Referring to FIGS. 5 and 6, the abscissa of the graph represents eigen numbers, and the ordinate of the graph represents eigen values.

For example, it is assumed that the apparatus 100 receives two incident signals through five antennas arranged in a circular shape. In this case, eigen values for the variance matrix of the reception signal are illustrated in FIG. 5. FIG. 5 illustrates eigen values for a variance matrix of a reception signal in a related art apparatus for estimating a DOA of a signal in accordance with the related. Here, it is assumed that the related art apparatus has antennas identical to those of the apparatus 100.

FIG. 5 illustrates related art eigen decomposition processing. Here, the eigen numbers 1 and 2 represent eigen values of a signal space, and the eigen numbers 3, 4 and 5 represent eigen values of a noise space. In this case, the eigen value of the signal space is different by an eigen value of ‘1’ or so from that of the noise space. The reference threshold value for estimating the number of signals may have an eigen value of ‘1’ or so.

FIG. 6 illustrates eigen decomposition processing in accordance with the embodiment of the present invention. Here, the eigen numbers 1 and 2 represent eigen values of a signal space, and the eigen numbers 3, 4 and 5 represent eigen values of a noise space. In this case, the eigen value of the signal space is different by an eigen value of ‘7.5’ or so from that of the noise space. The reference threshold value for estimating the number of signals may have an eigen value of ‘7.5’ or so.

In the communication system in accordance with the embodiment of the present invention, the eigen decomposition processing unit 142 performs eigen decomposition processing on the signal having the noise signal separated therefrom, so that the difference between the eigen value of the signal space and the eigen value of the noise space can be increased. Thus, in the embodiment of the present invention, the DOA estimation unit 140 can efficiently estimate the number of signals, and thus it can be seen that the DOA estimation performance is improved.

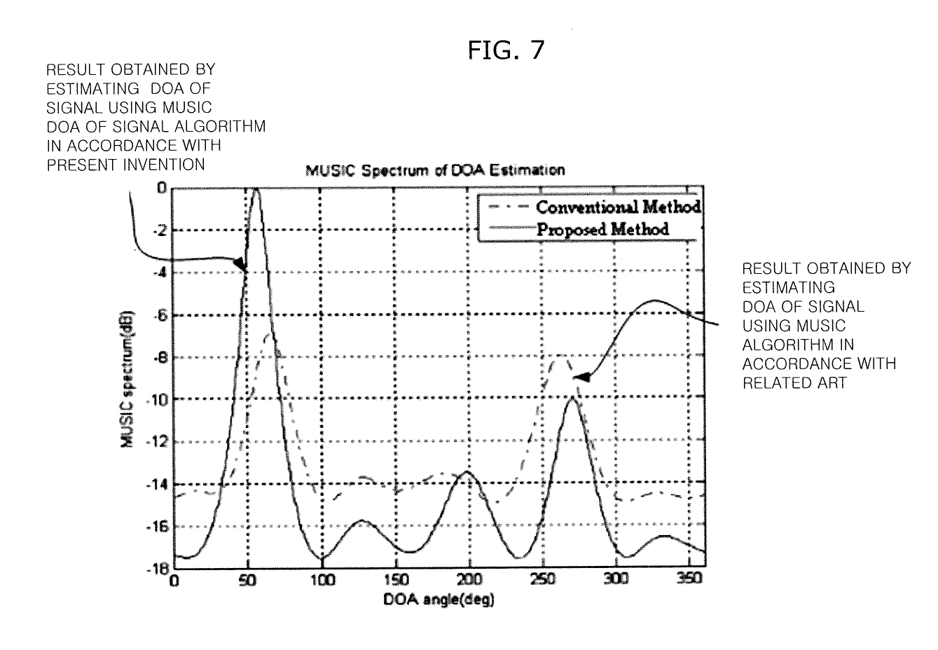

FIG. 7 is a graph illustrating a result obtained by estimating a DOA of a signal in the communication system in accordance with the embodiment of the present invention.

Referring to FIG. 7, the abscissa of the graph represents DOA angles, and the ordinate of the graph represents spectra (dB) for DOA estimation.

The DOA estimation unit 140 estimates a DOA of a signal of which noise element is reduced. That is, the DOA estimation unit 140 receives a signal having a noise signal separated therefrom through denoising of a signal converted into a signal of a frequency region.

Meanwhile, it is assumed that the DOA estimation unit 140 estimates a DOA of a signal using the MUSIC algorithm. The dotted line in the spectrum of FIG. 7 indicates a result obtained by estimating a DOA of a signal using a related art method for estimating a DOA of a signal. The solid line in the spectrum of FIG. 7 indicates a result obtained by estimating a DOA of a signal using the method for estimating the DOA of the signal in accordance with the present invention. For example, it can be seen that the DOA angle is about 60 degrees.

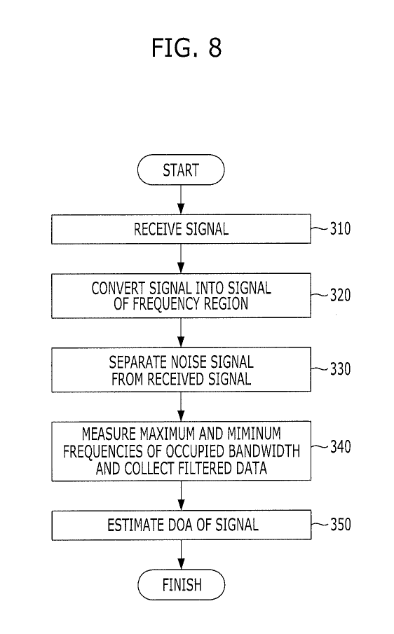

FIG. 8 is a flowchart illustrating a method for estimating a DOA of a signal in the communication system in accordance with the embodiment of the present invention.

Referring to FIG. 8, at step 310, the signal reception unit 110 receives a signal. The signal reception unit 110 outputs the received signal to the pre-processing unit 120. Here, the received signal is a signal of a time region.

At step 320, the pre-processing unit 120 converts the received signal of the time region into a signal of a frequency region, i.e., frequency analysis region.

At step 330, the pre-processing unit 120 separates a noise signal from the received signal converted into the signal of the frequency analysis region. Here, the noise signal is a signal except an original signal to be received, and may contain an interference signal. The pre-processing unit 120 outputs, to the signal rearrangement processing unit 130, the signal having the noise signal separated therefrom.

At step 340, the signal rearrangement processing unit 130 measures maximum and minimum frequencies of an occupied bandwidth by setting the occupied bandwidth from the signal having the noise signal separated therefrom. The signal rearrangement processing unit 130 collects data obtained by filtering a noise region, i.e., the noise signal, through processing of the maximum and minimum frequencies of the occupied bandwidth. That is, the signal rearrangement processing unit 130 extracts only a signal element existing in the occupied bandwidth. The signal rearrangement processing unit 130 outputs the data obtained by filtering the noise signal to the DOA estimation unit 140.

At step 350, the DOA estimation unit 140 estimates a DOA of a signal from the collected data. The DOA estimation unit 140 receives the signal of which noise element is reduced through the steps 320 to 340. That is, DOA estimation unit 140 receives the signal with improved SINR.

The apparatus in accordance with the embodiment of the present invention can distinguish information on the signal space from information on the noise space in the estimation of the DOA of the signal through the reduction of the noise signal. Further, the apparatus 100 applies a denoising method to the noise space through pre-processing based on the time-frequency region conversion of the signal of the time region into the signal of the frequency analysis region, so that it is possible to improve the SINR of the received signal for measuring the occupied bandwidth and estimating the DOA of the signal.

That is, the apparatus in accordance with the embodiment of the present invention uses a digital signal processing method. The apparatus 100 performs denoising based on the time-frequency conversion from a digital-processed time sample. The apparatus 100 determines maximum and minimum frequencies of an occupied bandwidth of a signal in the frequency region through the denoising, and outputs sample data obtained by filtering noise and interference using the maximum and minimum frequencies. The apparatus 100 improves the SINR of the received signal using the sample data, so that it is possible to improve DOA estimation performance.

In the apparatus 100, the denoising method in the frequency region and the filtering method through the measurement of the occupied bandwidth for removing noise elements may be used together or may be individually used.

That is, in the embodiment of the present invention, there is provided an apparatus and method for estimating a DOA of a signal, which can be applied to an environment in which noise and interference exist, and improve DOA estimation performance by estimating a DOA of a signal source through denoising and measurement of an occupied bandwidth.

In accordance with the exemplary embodiments of the present invention, a noise signal is separated through denoising based on time-frequency region conversion in a communication system, so that it is possible to reduce an error caused by estimating a DOA of a signal due to the noise signal. Further, although a signal with a low SINR is received, it is possible to improve DOA estimation performance.

While the present invention has been described with respect to the specific embodiments, it will be apparent to those skilled in the art that various changes and modifications may be made without departing from the spirit and scope of the invention as defined in the following claims.

What is claimed is:

1. An apparatus for estimating a direction of arrival (DOA) of a signal in a communication system, the apparatus comprising:
a signal reception unit configured to receive a signal;
a pre-processing unit configured to convert the received signal into a signal of a frequency region and denoise the signal converted into the signal of the frequency region;
a signal rearrangement processing unit configured to measure an occupied bandwidth through spectrum analysis of the denoised signal and filter a noise region based on the occupied bandwidth; and
a DOA estimation unit configured to estimate a DOA of the signal obtained by filtering the noise region using a DOA estimating algorithm.

2. The apparatus of claim 1, wherein the pre-processing unit comprises:
a time-frequency region conversion unit configured to convert a signal of a time region into a signal of a frequency region; and
a denoising unit configured to perform a denoising operation for separating a noise signal from the signal converted into the signal of the frequency region.

3. The apparatus of claim 2, wherein the denoising unit separates the noise signal using a wavelet denoising algorithm.

4. The apparatus of claim 1, wherein the signal rearrangement processing unit comprises:
an occupied bandwidth measurement unit configured to obtain maximum and minimum frequencies from the bandwidth occupied by the denoised signal; and
a rearrangement unit configured to filter the noise region through the maximum and minimum frequencies obtained using the occupied bandwidth and arrange filtered signals.

5. The apparatus of claim 4, wherein the occupied bandwidth measurement unit obtains the maximum and minimum frequencies using an ex-decibel (x-dB) bandwidth measuring method or a partial power (β %) bandwidth measuring method in the received signal pre-processed through the denoising operation.

6. The apparatus of claim 5, wherein the occupied bandwidth is an occupied bandwidth containing a signal element of the received signal.

7. The apparatus of claim 1, wherein the signal reception unit comprises:
an arrangement antenna unit configured to receive the signal;
an intermediate frequency conversion unit configured to convert the received signal into an intermediate frequency signal; and
an analog/digital conversion unit configured to collect a signal through sampling of the intermediate frequency signal and convert the collected signal into a digital signal.

8. A method for estimating a DOA of a signal in a communication system, the method comprising:
receiving a signal;
converting the received signal into a signal of a frequency region;
separating a noise signal from the signal converted into the signal of the frequency region;
filtering a noise region by setting an occupied bandwidth from the signal having the noise signal separated therefrom; and
estimating a DOA of the signal obtained through the filtering of the noise region.

9. The method of claim 8, wherein said converting of the received signal into the signal of the frequency region comprises:
obtaining a time sample by sampling the received signal and converting the sampled signal into a digital signal; and
converting the time sample into a signal of a frequency region.

10. The method of claim 8, wherein said separating of the noise signal comprises separating a noise signal from an original signal through denoising in the signal converted into the signal of the frequency region.

11. The method of claim 10, wherein said filtering of the noise region comprises:
setting the maximum and minimum frequencies of the occupied bandwidth; and
filtering the noise region containing the noise signal using the maximum and minimum frequencies.

12. The method of claim 11, wherein said setting of the maximum and minimum frequencies of the occupied bandwidth obtains the maximum and minimum frequencies using an ex-decibel (x-dB) bandwidth measuring method or a partial power (β %) bandwidth measuring method in the received signal pre-processed through the denoising.

13. The method of claim 8, wherein the estimating of the DOA of the signal comprises:
estimating a variance matrix from the signal obtained through the filtering of the noise region;
decomposing an eigen value from the variance matrix;
estimating a number of signals for DOA estimation by distinguishing a number of signal spaces and a number of noise spaces from the size of the eigen value; and
estimating the DOA of the signal through the estimation of the number of signals.

14. A method for estimating a DOA of a signal in a communication system, the method comprising:
receiving a signal;
converting the received signal into a digital signal through sampling;
converting the digital signal into a signal of a frequency region;
separating a noise signal from the signal of the frequency region;
obtaining maximum and minimum frequencies of an occupied bandwidth through spectrum analysis from the signal having the noise signal separated therefrom;
filtering a noise region containing the noise signal using the maximum and minimum frequencies; and
estimating a DOA of the signal obtained by filtering the noise region.

15. The method of claim 14, wherein said separating of the noise signal comprises separating the noise signal by denoising the signal of the frequency region.

16. The method of claim 14, wherein said estimating of the DOA of the signal comprises:
estimating a variance matrix from the signal obtained through the filtering of the noise region;
decomposing an eigen value from the variance matrix;
estimating a number of signals for DOA estimation by distinguishing a number of signal spaces and a number of noise spaces from the size of the eigen value; and
estimating the DOA of the signal through the estimation of the number of signals.
